(19) United States
(12) Patent Application Publication
(10) Pub. No.: US 2015/0039401 A1
(43) Pub. Date: Feb. 5, 2015

(54) METHOD AND SYSTEM FOR IMPLEMENTATION OF ENGINEERED KEY PERFORMANCE INDICATORS

(71) Applicant: International Business Machines Corporation, Armonk, NY (US)

(72) Inventor: John Arthur Ricketts, Clarendon Hills, IL (US)

(73) Assignee: International Business Machines Corporation, Armonk, NY (US)

(21) Appl. No.: 13/958,974

(22) Filed: Aug. 5, 2013

(51) Int. Cl. G06Q 10/06

(52) U.S. Cl. CPC G06Q 10/06393
USPC 705/7.39

(57) ABSTRACT

A method and system engineers Key Performance Indicators (KPIs). This method and system helps KPI engineers: 1) design effective KPIs based on target KPI behavior and performance leverage points; 2) validate KPI designs against sample sensor data while taking into account goal, resource, and policy changes; 3) verify that KPIs are usable and flexible based on user & owner feedback; and 4) calibrate KPIs for environmental and operational changes, plus anomalies.

### FIELD OF THE INVENTION

This invention relates to the use of Key Performance Indicators (KPIs) to evaluate the performance of a particular activity. In particular, this invention relates to a method and system for engineering Key Performance Indicators and using these engineered KPIs to evaluate the performance of a particular activity.

### BACKGROUND OF THE INVENTION

Key Performance Indicators (KPIs) are a set of quantifiable measures that a company or industry uses to gauge or compare performance in terms of meeting their strategic and operational goals. KPIs vary between companies and industries, depending on their priorities or performance criteria. A company must establish its strategic and operational goals and then choose the KPIs which best reflect those goals. For example, if a software company's goal is to have the fastest growth in its industry, its main performance indicator may be the measure of revenue growth year-on-year. Also, KPIs will often be industry-wide standards, like “same store sales”, in the retail sector.

Key Performance Indicators are quantifiable measurements. An organization usually agrees to these KPIs in advance. The agreed to KPIs generally reflect the critical success factors of the organization. The KPIs will differ depending on the organization. For example, a business may have as one of its KPIs the percentage of its income that comes from return customers. A school may focus its KPIs on graduation rates of its students. A customer service department for a company may have as one of its KPIs, the percentage of customer calls answered in the first minute. This KPI can be a component of an overall company KPI. A Key Performance Indicator for a social service organization might be number of clients assisted during the year.

Many major corporations rely on Key Performance Indicators (KPIs) for alerting and reporting. Though intuition and experience can lead to effective KPIs, when this is not the case, too many or too few alerts will be triggered and reports may not be sufficiently useful by users and owners. In addition, KPIs may not be adapted effectively for changing conditions. When KPIs are established informally, fundamental assumptions may not be explicit. For example, using the mean and standard deviation to set KPI ranges implicitly assumes that the underlying sensor values follow the normal distribution. However, sensor values underlying some KPIs follow other distributions. When KPIs are borrowed from previous projects, from standards, or from training examples, these KPIs may not fit a particular operational scenario. For example, traffic flows on an urban highway segment and a suburban highway segment are unlikely to be the same even if they have the same lanes. When KPIs are established for specific times or locations, the conditions may not be universal. For example, water usage at 6:00 AM and 6:00 PM are unlikely to be the same as usage at noon or midnight. When KPIs are established for typical conditions, those KPIs may be inappropriate for atypical conditions. For example, calls for emergency services on a typical day are unlike what happens during parades, protests, riots, fires, floods, storms, heat waves, or outbreaks of contagious illness.

Companies have relied on the use of KPIs for many years. For example, U.S. Patent Application number 20120095734 describes a method of optimizing a Business Process Management (BPM) model, where the model is associated with a plurality of key performance indicators depending on a control parameter vector that includes a plurality of control parameters, may include separating the plurality of control parameters into a linear control parameter vector and a non-linear control parameter vector. A set of candidate values may be iteratively calculated for the control parameter vector. Each candidate value may be determined for a preselected value of a non-linear control parameter belonging to the non-linear control parameter vector from execution of a mixed integer program model associated with the BPM model, the key performance indicators and the preselected value of the non-linear control parameter vector. The method may further include adjusting the BPM model based on at least one of the candidate values.

U.S. Patent Application number 20120046999 describes a method for managing performance of an IT service delivery process to ensure the changes meet service performance objectives. Key performance metrics (KPIs) of a service delivery process are collected in a continuous manner at defined time intervals, both before a change to improve performance is applied to the process (baseline measurements) and after a change is applied to the process (post-change measurements). A process behavior graph is generated comprising each baseline and post-change performance measurement at the time interval collected, the time interval at which the change was applied to the process, and the performance objectives for the process. The graph is displayed to a user to enable the user to determine the impact the change has on the service delivery process in view of differences between the baseline and post-change performance measurements, and to determine whether the process meets performance objectives in view of the performance objectives.

U.S. Patent Application number 20110184785 describes a methodology for monitoring and tracking of process changes, special cause occurrences, and process improvement actions, and their effects on correlated processes, which includes the following steps: identifying the targeted processes, defining the key performance indicator(s) (KPIs) for the processes, selecting the appropriate frequency of the data points (i.e. daily, weekly, monthly, etc), capturing and reflecting the data points every completed period on a tracking chart or similar visual aid, and document significant events, special cause occurrences, and process improvement action start dates in a visually correlated matrix or data table, with data point dates serving as alignment indices.

U.S. Pat. No. 8,112,306 to Lyerly et al, describes systems and methods that provide a notification engine that facilitates integration of solutions for performing workforce management, quality monitoring, e-learning, performance management, and analytics functionality. The notification engine facilitates combining quality monitoring/call recording with performance management and e-learning functionality as a unified integrated solution. The combination can be delivered through a single platform and enables users to gain more insight and make smarter decisions faster about sales, service, and overall operations. This takes customer center tools beyond the traditional “suite” approach to a true single workforce optimization platform.

Google also provides a KPI validation product. This product known as “Large Scale Service Solutions” www.almaden.ibm.com/asr/projects/lsss, provides financial modeling that focuses on combining data, models and KPIs for costing of products and services for budget management. This system uses a feedback loop to optimize financial models by comparing project data with established KPIs. However, this system does not address error detection, outlier elimination, KPI distributions, how KPI thresholds are set initially, or how KPIs are adjusted.

As mentioned, many corporations rely on Key Performance Indicators (KPIs) for alerting and reporting. Prior focus on KPIs has been the use or implementation of KPIs to collect various forms of data. However, the use of the KPIs has been based on past experience or on standard KPIs that have been in use for many years. Little effort if any is devoted to the development of new KPI parameters. There remains a need for a method and system that can engineer new KPIs that have more relevance to the changes that are occurring in society. Newly engineered KPIs can provide more accurate data for alerting and reporting.

### SUMMARY OF THE INVENTION

The present invention provides a method and system for engineering Key Performance Indicators (KPIs). This invention helps KPI engineers: 1) design effective KPIs based on target KPI behavior and performance leverage points; 2) validate KPI designs against sample sensor data while taking into account goal, resource, and policy changes; 3) verify that KPIs are usable and flexible based on user & owner feedback; and 4) calibrate KPIs for environmental and operational changes, plus anomalies.

An embodiment of the system of the present invention can provide modules for KPI analysis, KPI validation, KPI verification and KPI calibration. The system of the present invention further comprises a KPI library that stores information about past KPIs. An Intelligent Operations Center processes information from KPIs and has the capability to generate reports, alerts, maps and videos.

An embodiment of the method of the present invention is the process for engineering Key Performance Indicators (KPIs). This method comprises gathering data samples, computing distribution samples and defining or refining KPI parameters. This method ultimately evaluates whether the goals of the KPI parameters are met. The result is a refined set of KPI parameters that are better suited for a particular application than traditional KPI parameters.

### DESCRIPTION OF THE DRAWINGS

FIG. 1 is a configuration of the components in the system for engineering of Key Performance Indicators (KPIs) in accordance with the present invention.

FIG. 2 is a flow diagram of the steps in the method for engineering of Key Performance Indicators (KPIs) in accordance with the present invention.

### DETAILED DESCRIPTION OF THE INVENTION

As mentioned, Key Performance Indicators (KPIs) are quantifiable measures used to gauge or compare performance in terms of meeting their strategic and operational goals. As technology changes, systems and activities measured by KPIs also change. Furthermore, how KPIs are implemented to measure performance during these activities has also changed. For example, in the application of KPIs, because of technology, companies have moved from a paper based KPI system to a software based KPI system. However, in the change over from the paper based KPI system to the software based KPI system, people still have the tendency to use the conventional KPI measurements. The present invention addresses this application of conventional KPI measurements to newly encountered situations.

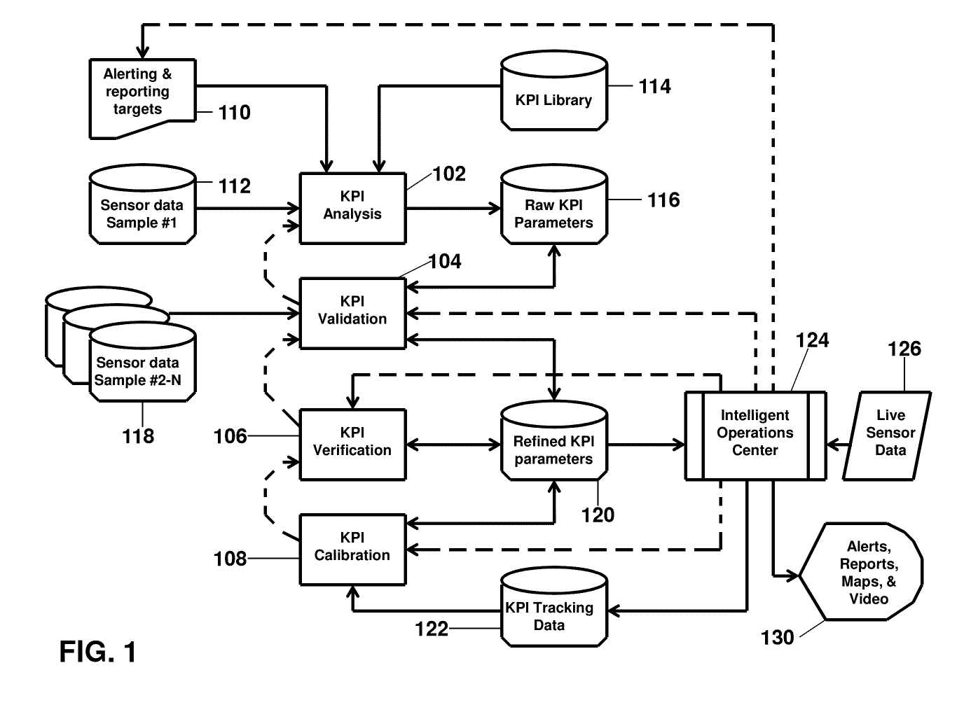

Referring to FIG. 1, shown is a configuration of the implementation of the system of the present invention. This system has the capability to engineer new KPI measurements that should more accurately measure certain conditions. As shown in FIG. 1, the KPI implementation of the present invention has four phases: analysis, validation, verification and calibration. The implementation of each phase combines software and human functions. The first phase shown by box 102 is KPI analysis function. This analysis phase uses data from various modules including an alerts and reporting targets module 110, a sensor data sample #1 module 112 and data from a KPI library module 114 to analyze a sample KPI data. As shown, data from all three information sources is input into the KPI analysis box 102. The data from the alerting and reporting target component 110 can comprise several types of data. One data set can be conventional trigger levels or thresholds. When a measured activity reaches an established level, there is a trigger to record a measurement. For example, there can be a trigger alert a measured pressure drops below 30 psi. A second measurement can be target status frequency. How many times does a measured activity reach this target? For example, if the measured activity reaches an established target threshold 80% of the time, a green color would indicate that status of the activity. However, if the target frequency drops to 15%, a yellow color would indicate that status level. If the target activity drops even lower to 5%, the color red would indicate that status. A third input measurement from the alerts and reporting targets module 110 is expected lead and load times. This data set may be derived from an established time for an event and an alert issued approximately third minutes before the event. This function could be similar to a warning. Other data sets from the alerts and reporting targets module 110 could include general collecting of information for reporting such as: locations, time periods, response types, recipients. Also included in the alerts and reporting targets module 110 could data from a reasonableness test such as the scenario when a valid sensor's pressure value is >=0 and <=200 psi. In this scenario other sensor values could indicate a likely malfunction or failure in a sensor communication.

As shown, a sample sensor data module 112 feeds data into the KPI analysis function 102. This data can comprise files of time stamped sensor values. Examples of this data can include traffic data gathered from traffic sensors. This data is used to analyze distributions, outliers, and anomalies. An example is the multi-modal distribution.

The KPI library 114 stores information about past KPIs, such as KPI water standards. The types of stored sensor data can include units, time, flow (units/time) and statistics. The KPI library also has expected distributions for each KPI such as Normal, Exponential and Rayleigh. Other data stored in the KPI library includes durations for aggregations such as total every 5 minutes, average over 15 minutes. In addition, range types: direction, boundaries, symmetry are stored in the KPI library. In the configuration of the present invention, data flows between the KPI analysis box 102 and the KPI library 114.

The analysis from the KPI analysis function 102 produces newly generated KPI parameters that are transmitted to the raw KPI parameters module 116. These newly engineered parameters include types and parameters for distributions. These generated parameters can include outliers, leverage points and accuracy such as speed based on GPS vs. road sensors. Included in these generated raw parameters are alerting and reporting rules such as alerts only after in red zone for preset minimum period to suppress alerts on transient spikes that naturally regress toward the mean. The raw parameters can also include KPI labels and ranges. The raw KPI parameters module 116 is also in communication with the KPI validation module 104 and transmits raw KPI parameters to the KPI validation module for parameter validation.

Referring again to FIG. 1, phase 2 shown by box 104 is the KPI validation function. This phase validates the raw KPI parameters engineered and generated in the KPI analysis phase 102. This phase validates KPI parameters against sample sensor data while taking into account any goals, resources and policy changes. As shown, the KPI validation box 104 receives data from several inputs. First, the KPI validation box receives the generated raw KPI parameters from phase 1. A second sensor data sample module 118 feeds data into the KPI validation function 104. From this sensor data sample and raw KPI parameters, the KPI validation function determines whether the KPI parameters produce the desired alerts & reports on different sensor samples. If these KPI samples do not produce the desired alerts & reports on different sensor samples, the KPI validation will refine the KPI parameters, and if necessary return to Phase 1.

The KPI validation function also receives goal, resource, and policy changes data from the Intelligent Operations Center (IOC) 124. For a particular scenario, if the goals change, KPIs may need to change. For example, for an emergency response to a call, the goal may change from 10 minutes to 7 minutes. For particular scenario, if the resources change, the KPIs may need to change. For example, a reduction in security offers on duty may mean that a red alert should rise from 80% to 90%. Referring again to goals, resources and policy changes, in a particular scenario, if the policy changes, then the KPIs may need to change. For example, a no overtime policy may mean that a red alert threshold on the overtime budget should be reset.

The KPI validation function 104 also communicates with a refined KPI parameters module 120. This module has KPI parameters that are sent to the KPI validation function 104 to be refined and validated. The KPI parameter refining process may include adjusting range colors, range boundaries, aggregation periods, and alert suppressions to align alerts and reports with defined targets. The KPI parameter refining process may also include defining when to switch between sets of KPI parameters such as: time of day, calendar (ex: day of week), workload (low, normal, high), and urgency (normal, emergency).

Referring again to FIG. 1, phase 3 shown by box 106 is the KPI verification function. This phase verifies that KPIs are usable and flexible based on user & owner feedback. The user and owner feedback information comes from the Intelligent Operations Center (IOC) 124. Regarding the user feedback, users could respond to the question “Do KPI parameters produce timely alerts & usable reports?” If the user feedback is that KPI parameters do not produce timely alerts & usable reports, the system response could be to return to the KPI validation function in phase 2, if necessary. The owner feedback can vary and can include several types of feedback such as:
False positives—alerts triggered for wrong time, wrong place, wrong resource, or wrong reason;
False negatives—missed or late alerts;
Transient alerts—sensor spikes that naturally regress out of alert zone;
Information overload—too many alerts triggered at once, reports not summarized;
Alert prioritization—alerts with highest severity or most impact should float to top when many alerts occur simultaneously; and
Reporting problems—errors in calculations, unexplained disparities between periods or locations or resources, cannot drill down to details as needed.

The KPI Verification function 106 also communicates with the refined KPI parameters module 120. This module has KPI parameters that are sent to the KPI verification function 106 to be refined and verified for usability. Similar to the refining process in the KPI validation function, in the KPI verification function, the KPI parameter refining process may include adjusting range colors, range boundaries, aggregation periods, and alert suppressions to align alerts and reports with defined targets for usability.

In FIG. 1, phase 4 shown by box 108 is the KPI calibration function. This function calibrates KPIs for environmental and operational changes. The KPI calibration function receives input data from the KPI tracking data module 122 and the refined KPI parameters module 120. The KPI tracking data module provides tracking data that includes status statistics such as the percent of time a condition is in a green state, a yellow state or a red state. The actual scenario from which these particular data states can come is a traffic monitoring system. The KPI tracking module also tracks actual performances and for example determines whether the percentage of red alerts exceeds a target threshold. In addition, the KPI tracking data module monitors system performance and determines if the performance is improving. The KPI tracking module also determines whether actual performance goals are being attained. The KPI tracking module keeps a log of outliers and anomalies in system performances. These outliers and anomalies can comprise erroneous data, missing data, data failing reasonableness tests. Also occurring in the KPI calibration module is a determination of whether KPI parameters produce alerts and reports that are aligned with field activities as well as the activities in the operations center. If the determination is that the KPI parameters produce alerts and reports that do not align field activities with center activities, then it may be necessary to refine the KPI parameters and return to the KPI verification function.

Referring back to the KPI calibration function, the Intelligent Operations Center (IOC) 124 provides notification of operational changes from users or process owners. The changes within the Operations Center itself can be for example a priority for KPIs to be shown on big screen in the center. Another change could be changes in the standard operating procedures (SOPs) for the field activities. An example of this change is when to invoke reciprocal agreement with neighboring providers of police, fire, and ambulance services.

With regards to notification of environmental changes, these change notifications can show up in sensor data or it can come from users or process owners. Examples of environmental changes can be over-topping of a levee and lane restrictions on road.

The KPI calibration function 108 also communicates with the refined KPI parameters module 120. This module has KPI parameters that are sent to the KPI calibration function 108 to be refined and verified for usability. Similar to the refining process in the KPI validation and verification functions, in the KPI calibration function, the KPI parameter refining process may include adjusting range colors, range boundaries, aggregation periods, and alert suppressions to align alerts and reports with defined targets for usability.

Once the new KPI parameters are generated at the KPI analysis function 102, and then validated 104, verified 106 and calibrated 108, the refined KPI module 120 sends the parameters to the Intelligent Operations Center (IOC) 124 in phase 5. The refined KPI parameters are applied to the Intelligent Operations Center (IOC) 124. The application of the KPI parameters enables the KPI tracking of data in the Intelligent Operations Center (IOC) 124. The IOC can also receive live sensor data 126. In the IOC, the tracking may be at different granularity or frequency from KPI data reported to users. The tracking function may also be on/off as needed for system performance reasons. The functioning of the IOC generates alerts, reports, maps and video data 130. Users are able to observe organizational performances relative to goals and make determinations regarding the goals are: improving, remaining steady, or declining. Based on these observations, users or the system can take actions depending on the information. In the observations, if goals for organizational performance not being met, the response is to return to Phase 1. If goal, resource, or policy changes occur, the response is to return to Phase 2. If user feedback indicates problems, the response is to return to Phase 3. If environmental or operational changes occur, the response is to return to Phase 4.

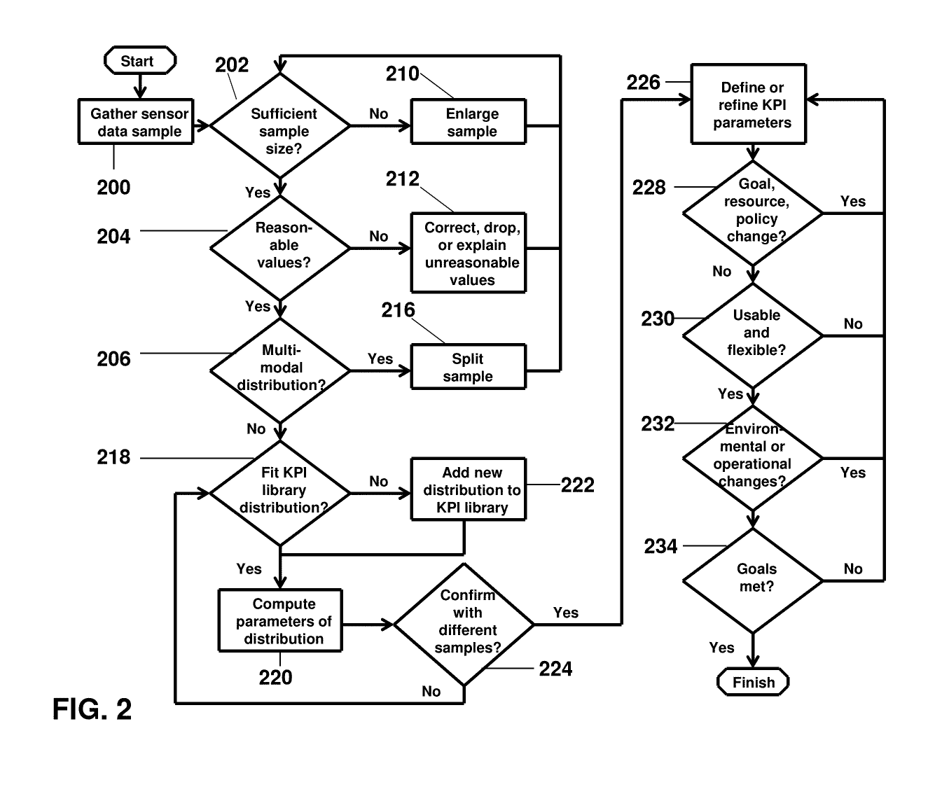

Referring to FIG. 2, the present invention also describes a method and process for engineering Key Performance Indicators (KPIs). As mentioned, these newly engineered KPIs can provide a more accurate means to analyze various activities. This process starts through the implementation of sensors to gather data. This approach is similar to convention KPI data gathering. In this method, step 200 gathers sensor data and retrieves sensor data samples. After retrieving data sample, step 202 determines whether the sample size is sufficient sample size to perform KPI analysis. If the determination is that the sample size of the retrieved data is not sufficient, the sample size is enlarged in step 210. Once the larger sample is taken, the method returns to step 202. In step 202, if the determination is that the sample size is sufficient, the method moves to step 204 which determines if the values of the data in the data sample are reasonable. Referring to both the sample size and the reasonableness of the data sample, reference values, standards or thresholds for both are established and stored prior to the initiation of this method in the present invention. In step 204, if the determination is that the values are not reasonable, the method of the invention move to step 212 which corrects, drops or provides an explanation for the unreasonable values. After the processing of the data in step 212, as shown the method returns to step 202. Referring back to the reasonable values determination in step 204, if the determination is that the values are reasonable, the method moves to step 206 which determines if there is a multiple modal distribution of the sample. If there are multiple samples in the distribution, the method moves to step 216 which splits the sample and then returns the method to step 202.

Referring to step 206, if the determination is that there are not multiple samples in the distribution, then the method moves to step 218 which determines if the single distribution fits any distributions stored in the KPI library. If the single distribution does fit a distribution stored in the KPI library, the method moves to step 220 which computes the parameters for distribution. If step 218 determines that the single modal distribution does not fit a distribution stored in the KPI library, then step 222 will add the single modal distribution to the KPI library. Once the single modal distribution is stored in the KPI library, the method moves to step 220 which as previously stated computes the parameters for distribution based on this single modal distribution.

At this point, step 224 attempts to confirm the computed parameters in step 220 with different distribution samples. If the confirmation attempt is not successful, the method returns to step 218. If the confirmation attempt is successful, step 226 defines or refines the computed KPI parameters. At this point, step 228 determines whether there are goal, resource or policy changes in the parameters. If there are no changes detected changes in the goals, resources or policies, then the method moves to step 230 which determines if the defined KPI parameters are usable and flexible. If in step 228, there is a determination that the goals, resources or policies of the KPI parameters has changed, then the method returns to step 226 to define or refine the KPI parameters. In step 230, if the determination is that the parameters are usable and flexible, the method moves to step 232 which determines whether there are environmental or operational changes in the KPI parameters. If in step 230, the determination is that the KPI parameters are not usable and flexible, then the method again returns to step 226. In step 232, if the determination is that there are environmental or operation changes, then the method returns to step 226. If there are no environmental or operation changes, then the method moves to step 234 where there is a determination of whether the KPI goals are met. If the goals are met, the method is complete. If however, the determination in step 234 is that the goals are not met, the method returns to step 226.

As previously mentioned, the present invention provides a method and system for engineering Key Performance Indicators (KPIs). The method and system of this invention are not limited to financial KPIs or service solutions. The present invention generates and provides KPI Engineering Workbench analyzes data in order to accomplish various objectives which include: 1) the detection and then elimination of or explanation for KPI errors and outliners; 2) a determination of whether KPI parameters follow an expected distribution; 3) the detection of multimodal distributions and disentangle the associated KPIs; 4) identification of leverage points where small decisions/actions produce big KPI improvements; 5) the determination of whether KPI is unidirectional or bidirectional; 6) the determination of whether KPI is bounded or unbounded; 7) determination of whether KPI ranges should be symmetric or asymmetric; 8) determination of whether different KPI thresholds are needed under various conditions; 9) the adjustment of KPI thresholds to reduce/eliminate false positives and false negatives; 10) the adjustment of KPIs for changes in goals, resources, and policies; 11) adjust KPIs for usability and flexibility based on user/owner feedback; and 12) adjust KPIs for environmental and operational changes.

It is important to note that while the present invention has been described in the context of a fully functioning data processing system, those skilled in the art will appreciate that the processes of the present invention are capable of being distributed in the form of instructions in a computer readable storage medium and a variety of other forms, regardless of the particular type of medium used to carry out the distribution. Examples of computer readable storage media include media such as EPROM, ROM, tape, paper, floppy disc, hard disk drive, RAM, and CD-ROMs.

We claim:

1. A system for implementation of engineered key performance indicators comprising:
a key performance indicator (KPI) analysis module capable of analyzing sample KPI data received by the KPI analysis module from various information sources;
a key performance indicator (KPI) validation module in communication with said (KPI) analysis module that validates the raw KPI parameters engineered and generated in the KPI analysis phase;
a key performance indicator (KPI) verification module capable of verifying that KPIs are usable and flexible, the verification of said (KPI) verification module based on user & owner feedback;
a key performance indicator (KPI) calibration module capable of calibrating KPIs for environmental and operational changes;
an Intelligent Operations Center (IOC) in communication with each said analysis, validation, verification and calibration modules, said IOC capable of processing information received from key performance indicators (KPIs), said IOC also having the capability to generate reports, alerts, maps and videos; and
a key performance indicator library for storing information about past KPIs, such as KPI water standards.

2. The system for implementation of engineered key performance indicators as described in claim 1 further comprising:
an alerts and reporting targets module that supplies data to said KPI) analysis module; and
a first data sample module that supplies data to said KPI) analysis module.

3. The system for implementation of engineered key performance indicators as described in claim 1 further comprising a second sensor data sample module capable of feeding data into said KPI validation module for determining whether the KPI parameters produce desired alerts.

4. The system for implementation of engineered key performance indicators as described in claim 1 further comprising a raw (KPI) parameters module that receives KPI analysis from said KPI analysis module, said raw (KPI) parameters module also being in communication with said KPI validation module and transmits raw KPI parameters to the KPI validation module for parameter validation.

5. The system for implementation of engineered key performance indicators as described in claim 1 further comprising a KPI tracking module in communication with said Intelligent Operations Center (IOC) and said KPI validation module, said KPI tracking module capable of provides tracking data that includes status statistics such as the percent of time a condition is in a green state, a yellow state or a red state.

6. The system for implementation of engineered key performance indicators as described in claim 4 further comprising a refined KPI parameters module, said refined KPI parameters module being in communication with said KPI validation, KPI verification, KPI calibration modules and being in communication with said Intelligent Operations Center (IOC), said refined KPI parameters refines initial KPI parameters from said validation, verification and calibration modules and sends the refined parameters back to said modules after refining.

7. The system for implementation of engineered key performance indicators as described in claim 1 further comprising live sensor data transmitted to said Intelligent Operations Center (IOC)

8. A method for implementation of engineered key performance indicators comprising:
gathering and retrieving sensor data and sensor data samples;
determining whether there is a sufficient sample size of the gathered and retrieved sensor data perform KPI analysis;
when the sample size is sufficient, determining whether values of the data in the data sample are reasonable;
determining whether there is a multiple modal distribution of the sample;
when there is a single modal distribution of the sample, determining whether the single distribution fits any distributions stored in a KPI library;
when there is a single distribution fit, computing KPI parameters for distribution;
defining KPI parameters; and
determining whether KPI goals are met based on the defined parameters.

9. The method for implementation of engineered key performance indicators as described in claim 8 further comprising after said defining KPI parameters:
determining whether there are goal, resource or policy changes in the defined parameters;
when the determination is that there are no goal, resource or policy changes, determining whether the defined KPI parameters are usable and flexible; and
when the determination is that defined KPI parameters are usable and flexible, determining whether there are environmental or operational changes in the KPI parameters.

10. The method for implementation of engineered key performance indicators as described in claim 8 further comprising after said computing KPI parameters for distribution, confirming the computed KPI parameters with different distribution samples

11. The method for implementation of engineered key performance indicators as described in claim 8 further comprising when the determination is that there is not a sufficient sample size of the gathered and retrieved sensor data perform KPI analysis, enlarging the sample size and returning to said determining whether there is a sufficient sample size of the gathered and retrieved sensor data perform KPI analysis.

12. The method for implementation of engineered key performance indicators as described in claim 8 further comprising when the determination is that the values of the data in the data sample are not reasonable, correcting, dropping or providing an explanation for the unreasonable values and returning to said determining whether there is a sufficient sample size of the gathered and retrieved sensor data perform KPI analysis.

13. The method for implementation of engineered key performance indicators as described in claim 8 further comprising when the determination is that there is a multiple modal distribution of the sample, splitting the sample and returning to said determining whether there is a sufficient sample size of the gathered and retrieved sensor data perform KPI analysis.

14. The method for implementation of engineered key performance indicators as described in claim 8 further comprising when there is not a single distribution fit, adding a new distribution to a KPI library and then moving to said computing KPI parameters for distribution.
